(19) United States
(12) Patent Application Publication
(10) Pub. No.: US 2013/0240072 A1
(43) Pub. Date: Sep. 19, 2013

(54) Control Device for Paint Spraying Systems and Application Systems

(71) Applicant: HYDAC ACCESSORIES GMBH, Sulzbach/Saar (DE)

(72) Inventors: Jürgen KÄFER, Schiffweiler (DE); Bernd MICHEL, Schiffweiler (DE); Eric RINKENBACH, Diebling (FR)

(73) Assignee: HYDAC ACCESSORIES GMBH, Sulzbach/Saar (DE)

(21) Appl. No.: 13/762,632

(22) Filed: Feb. 8, 2013

(30) Foreign Application Priority Data
Mar. 13, 2012 (DE) 10 2012 005 080.1

(51) Int. Cl. B05B 7/24

(52) U.S. Cl. CPC B05B 7/24
USPC 137/637

(57) ABSTRACT

A control device for paint spraying systems and application systems which are used, in particular, for the quick-change application of paint in batch productions, with a piping system (1) carrying fluids, such as paint, lacquer, coating particles, and solvents of different cleanliness classes, with individual separating elements, such as pigs (15), enabling a fluid separation inside the piping system (1), is characterized in that individual control blocks (19, 21, 63) of the control device are composed of a plurality of actuatable switching valves (23, 25, 45, 47, 86, 87, 89, 90, 91), which enable, on the one hand, the input and/or output of pigs and/or, on the other hand, for this purpose, the simultaneous conveying of fluids in the piping system (1).

The invention relates to a control device for paint spraying systems and application systems which are used, in particular, for the quick-change application of paint in batch productions, with a piping system carrying fluids, such as paint, lacquer, coating particles, and solvents of different cleanliness classes, with individual separating elements, such as pigs, enabling a fluid separation inside the piping system.

Users of industrial paint spraying systems, such as those used, for example, in the assembly sequence in the automobile industry, are often confronted with the task of providing individual products (motor vehicles) or individual items of a batch production with a custom paint finish. In such cases, it is in the interest of an efficient and economical production to be able to quickly change the color, and this color change has to be performed with the spraying robots or hand spray guns that are in service without disrupting the flow of the assembly sequence. In order to satisfy this requirement, the production process is configured in such a way that the separation of the individual fluids is carried out inside the system's piping system that feeds the spraying robots and/or spray guns by conveying, on an alternating basis, charges of the different fluids, such as paint or cleaning solvents, through the piping system in succession and separated from each other. The amount of control engineering required for this purpose significantly increases the complexity and cost of existing systems.

With respect to the foregoing, the object of the present invention is to provide a control device that enables a quick change of the fluids to be applied to other components, such as the components of a vehicle body, at a low cost and with minimal technical complexity of the control system.

The invention achieves this object by means of a control device having the features specified in claim 1 in its entirety.

Accordingly, the control device according to the invention is characterized in that individual control blocks of the control device are composed of a plurality of actuatable switching valves, which enable, on the one hand, the input and/or output of pigs and/or, on the other hand, for this purpose, the simultaneous conveying of fluids in the piping system. The use of control blocks in which a plurality of switching valves, which perform a variety of control functions, are combined to form a control unit, reduces, compared to an operation of individual valve devices serving as control elements, both the complexity of the control system and also the design efforts, so that the result is a reduction in both the system costs and also the operating costs.

In especially advantageous exemplary embodiments, the piping system has an input control block at the beginning of a piggable pipeline that runs to at least one spraying station. This input control block has two switching valves, of which the first switching valve can be actuated as the controlling component of a pig launcher for the pigs and the second switching valve can be actuated to release and block the fluid inputs leading to the pipeline. The result of this arrangement is that all of the functions that are necessary for supplying the spraying station for the spraying operation and for changing the color can be executed by a single control block, in that one switching valve controls the fluid inputs for the fluids. In this case, one input can be provided for the paint, and at least one additional input can be provided for the cleaning solvents of different cleanliness classes, and the other switching valve for a necessary separation of the successive fluid flows controls the launching of the respective pigs.

The arrangement can be configured with a distinct advantage in such a way that the first switching valve of the input control block is arranged, based on the operational fluid flow, downstream of the second switching valve in the block and can be actuated for switching positions, in which either an input port for inserting a pig is released and a connection to the second switching valve is blocked, or this connection is released for the movement of the launched pig and/or the conveying of the respective fluid through the pipeline.

Preferably, the second switching valve, which is arranged upstream of the first switching valve in the input control block, can be actuated for switching positions, in which, on the one hand, a paint port is connected to the pipeline by means of a connection with the first switching valve; or, on the other hand, this connection is blocked; or, thirdly, the paint port is blocked, and the at least one fluid port for solvents of different cleanliness classes is connected to the pipeline by means of the connection with the first switching valve. Therefore, owing to the interaction of the first and second switching valves, all of the functions that are required to supply the spraying station and for changing the color are combined in one control block, including the launching of the necessary pigs.

The pipeline continues to run in an advantageous way from the respective spraying station to an end control block, which comprises two switching valves, of which one switching valve can be actuated for blocking and inputting an end of the pipeline that is connected to the block; and the second switching valve, which is situated downstream, is a controlling component of a pig receiver for pigs. The result of this arrangement is that once again the additional functions, which are necessary for retrieving the pertinent pigs, are also combined in one uniform control block.

The arrangement can be configured with a distinct advantage in such a way that a compressed air connection is provided at the fluid connection between the first and the second switching valve of the end control block. The result is that when the end of the pipeline is blocked, a pig, which has arrived at the end control block and is to be retrieved, can, through the admission of compressed air, be pushed out by way of the opened second switching valve.

In order to detect the position of the pig that is to be retrieved, a sensor, which signals the presence of a pertinent pig, can be provided at the fluid connection between the first and the second switching valve of the end control block. This approach can be implemented with a distinct advantage in such a way that the pigs have a permanent magnetic insert, so that a magnetic inductive sensor or a reed switch provides a notification signal.

In order to retrieve the pertinent pig, the arrangement can be configured in such a way that an output port for the pigs can be released or blocked with the second switching valve of the end control block.

Particularly advantageous exemplary embodiments provide a connecting line, which runs from the end control block to a distributor control block and which extends from a port at the end control block; and this port may be found at a fluid connection between the first and the second switching valve.

The distributor control block can comprise in an advantageous way five switching valves, which can be actuated for alternating connections from the connecting line to a first and/or a second paint reservoir or to a reservoir for slightly contaminated solvent or to a collector for highly contaminated solvent. The distributor control block can be used to recover the excess paint as well as the excess solvent, which was used in the course of the pig passage for precision cleaning, from the fluid flow, which arrives at said distributor control block from the pipeline, leaving the spraying station, by way of the end control block, for further use and to separate out the highly contaminated solvent that was used for preliminary cleaning.

The arrangement can be configured with a distinct advantage in such a way that the switching valves of at least one control block and preferably all of the control blocks are formed by ball valves comprising ball elements, which can be rotated by means of a respective controllable drive, which can be actuated as a function of the signal of an associated rotary position sensor and/or as a function of the signal of the pig sensor at the end control block and/or as a function of the signals from sensors that are distributed in the piping system and that detect the passing of pigs.

The invention is explained in detail below by means of one exemplary embodiment shown in the drawings. Referring to the drawings:

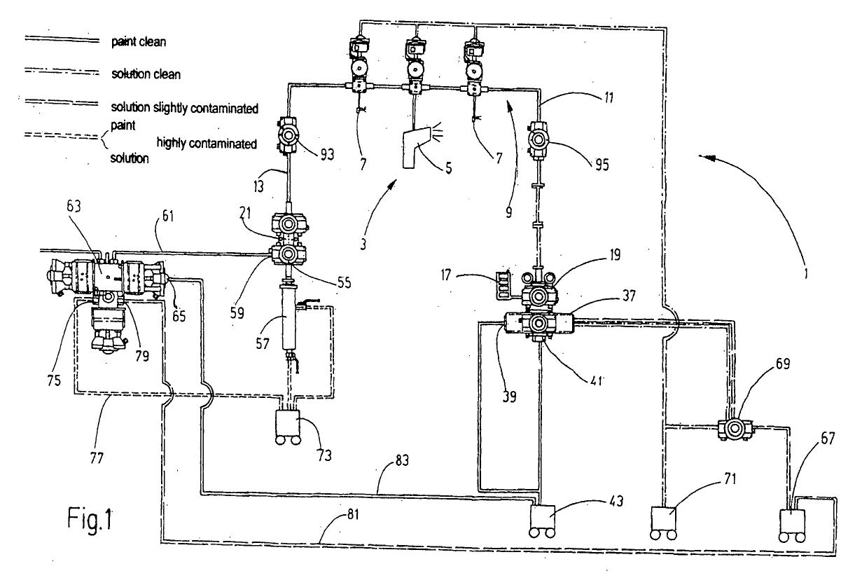

FIG. 1 is a highly simplified drawing in schematic form of the piping system of a paint spraying system, which is provided with an exemplary embodiment of the control device according to the invention;

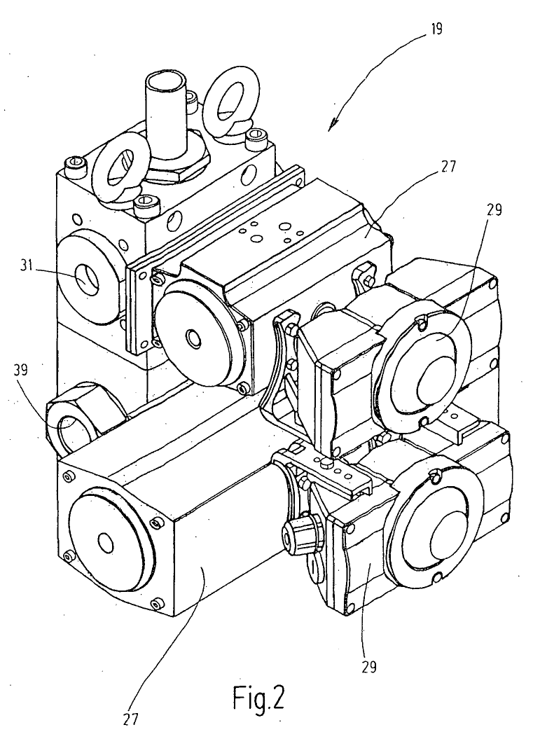

FIG. 2 is a perspective oblique view of an input control block of the exemplary embodiment of the control device according to the invention;

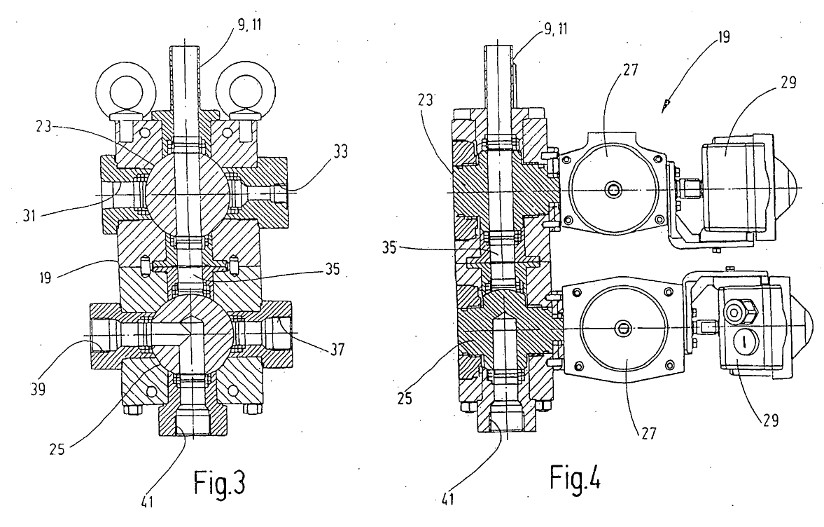

FIGS. 3 and 4 are longitudinal sectional views of the control block from FIG. 3 with the section planes rotated by 90 degrees with respect to each other;

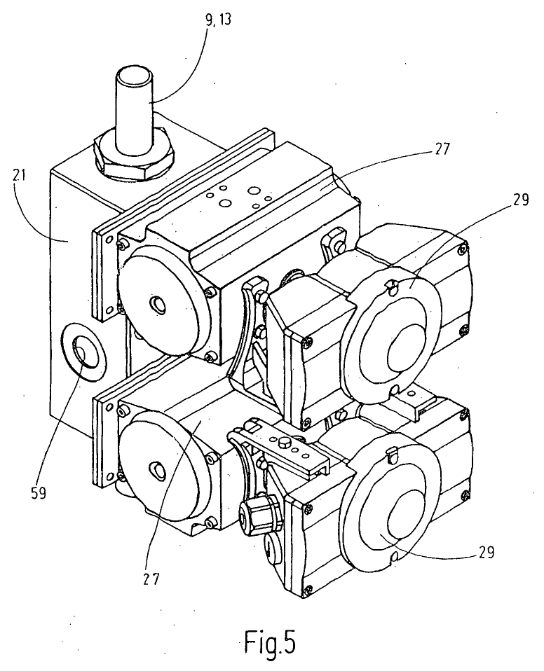

FIG. 5 is a perspective oblique view of an end control block of the exemplary embodiment;

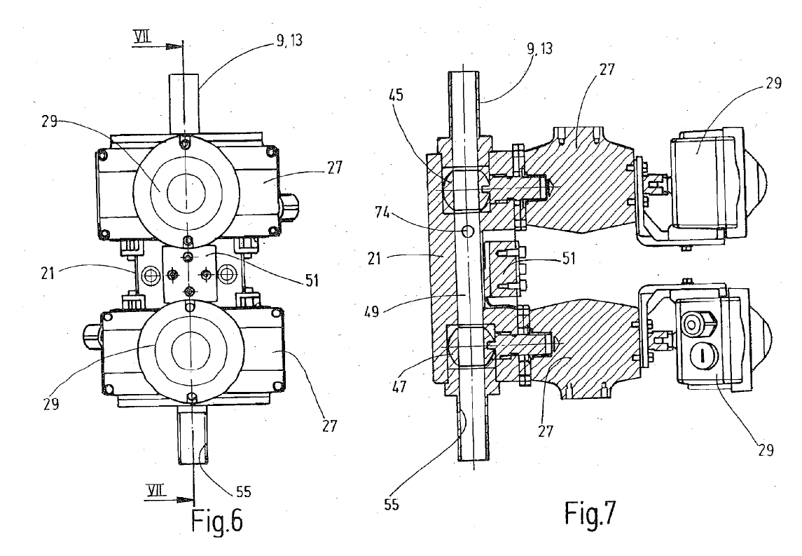

FIG. 6 is a side view of the control block from FIG. 5;

FIG. 7 is a longitudinal sectional view of the end control block according to the section line VII-VII from FIG. 6;

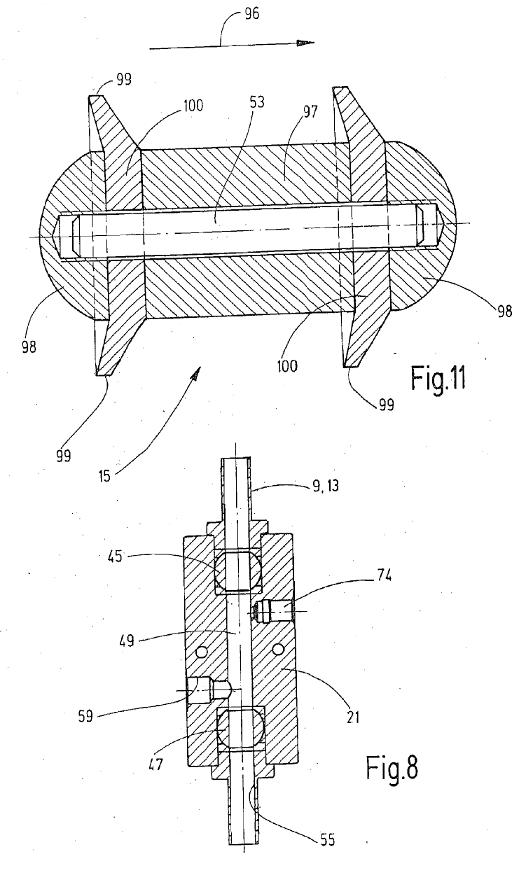

FIG. 8 is a longitudinal sectional view of the end control block with the section plane rotated by 90 degrees with respect to FIG. 7;

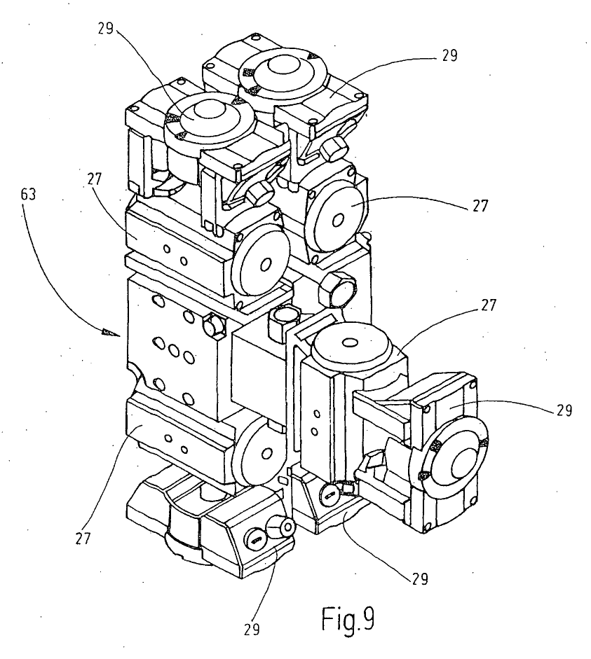

FIG. 9 is a perspective oblique view of a distributor control block of the exemplary embodiment;

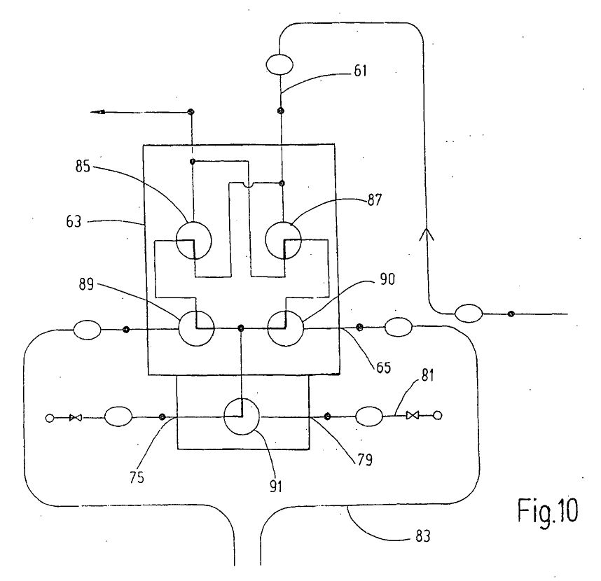

FIG. 10 is a highly simplified drawing in schematic form of the fluid circuit of the distributor control block from FIG. 9; and

FIG. 11 is a highly exploded longitudinal view of a pig for use in the control device according to the invention.

The invention is explained below by means of one exemplary embodiment, in which the control device is provided for the operation of a paint spraying system, as shown in schematic form in FIG. 1, whereby a spraying station 3 can be supplied by means of a piping system 1. In the exemplary drawing from FIG. 1, this spraying station is depicted by a spraying robot 5 and two hand spray guns 7. In order to be able to change the color for the spraying station 3, which is necessary for a clean separation of the fluids fed to the spraying station 3, the system makes use of the known pigging technology. For this purpose, the piping system 1 has a piggable pipeline 9 with an inflow section 11 upstream of the spraying station 3 and an outflow section 11 downstream of the spraying station 3. Pigs 15, of which only one is shown in an enlarged form in FIG. 11, are provided for the passage through the sections 11 and 13 of the pipeline 9. The pigs 15 can be launched into the pipeline from a magazine 17 by means of an input control block 19, which is located at the beginning of the inflow section 11 of the pipeline 9, and can be retrieved from the pipeline 9 by means of an end control block 21, which is located at the end of the outflow section 13.

The input control block 19, which is shown in detail in FIGS. 2 to 4, comprises two switching valves in the form of a ball valve 23 and 25 respectively as the fluid control elements. FIGS. 2 and 4 show that a rotary drive 27 in the form of a pneumatic drive is provided for the switching or rotary movement of the ball element of the ball valves 23, 25, with each drive 27 being assigned a rotary position sensor 29, which delivers an electric signal that signals the switching position of the associated ball valve 23, 25. In the drawing from FIGS. 3 and 4, the switching valve 23 is in a switching position in which it closes an input port 31, by way of which the pigs 15 can be inserted from the magazine 17, as well as a decompression port 33, by way of which the pressure can be reduced when a pig 15 is inserted. At the same time, a connection 35, which is formed in the control block 19, is connected to the section 11 of the pipeline 9 by means of the ball valve 23. In the illustrated state, the second ball valve 25 closes a fluid port 37, while a connection is established between the paint ports 39 and 41, so that a neutral paint circulation can take place in connection with a paint reservoir 43 (see FIG. 1). When the first ball valve 23 is rotated 90 degrees, starting from the switching position shown in FIGS. 3 and 4, a pig 15 can be launched from the magazine 17 by way of the input port 31. By continuing to rotate the first ball valve 23 by another 90 degrees into the position shown in FIGS. 3 and 4, the launched pig 15 can be moved through the pipeline 9 in that the second ball valve 25 is rotated out of the illustrated position in such a way that either the paint port 39 or the fluid port 37 is in fluid communication with the connection 35, so that the pertinent pig 15 is moved through the pipeline 9 due to the paint supplied from the paint port 39 or due to the fluid supplied from the fluid port 37.

FIGS. 5 to 8 show in more detail the end control block 21 at the end of the section 13 of the pipeline 9. The end control block 21 comprises, like the input control block 19, two switching valves in the form of a ball valve 45 and 47 respectively. Again, as in the case of the input control block 19, each ball valve 45, 47 has a pneumatic drive 27, which is assigned a rotary position sensor 29 for generating an electric position signal. A pig sensor 51 may be found at the inner fluid connection 49 between the first ball valve 45 and the second ball valve 47. When using pigs 15, which have a permanent magnetic core or a core 53 provided with magnetic particles (see FIG. 11), a magnetic inductive sensor or a reed contact can be provided as the pig sensor 51. The second ball valve 47 of the end control block 21 is a component of a pig receiver for pigs 15 that can leave by way of a pig receiver output 55 in the switching position shown in FIGS. 7 and 8. When the pig sensor 51 signals the presence of a pig 15 to be retrieved, the retrieval process can be carried out in such a way that the fluid admitted from the pipeline section 13 moves the pig 15 out of the end control block 21 by way of the output 55 when the ball valves 45 and 47 are opened. At the same time, the fluid displaced by this pig 15 is also expelled along with said pig. The issuing fluid together with this pig 15 passes into a collecting tank 57 (see FIG. 1). In the operating phases in which the pigs are not retrieved, the second ball valve 47 is closed; that is, the pig output 55 is blocked. When the first ball valve 45 is opened, the fluid that is outputted from the spraying station 3 over the section 13 of the pipeline 9 flows over the connection 49 in the end control block 21 to a connecting port 59 and, from there, over a connecting line 61 to a distributor control block 63. This distributor control block comprises five switching valves that in the present example are formed, as in the case of the two other control blocks 19 and 21, by ball valves, likewise with a pneumatic drive 27 and an electric rotary position sensor 29. Since, however, these switching valves do not have to be piggable, it is also possible to provide other types of valves that can be electrically actuated as a function of the control signals of the pig sensor 51 as well as other sensors (not depicted) that are distributed in the piping system 1 and that signal the passage of pigs.

In normal paint spraying operation, excess paint flows from the spraying station 3 over the connecting line 61 to the distributor control block 63 when the ball valve 45 is opened and the ball valve 47 of the end control block 21 is closed. In order to recover such excess paint, the distributor control block 63 establishes, starting from a paint output 65, the connection to the paint reservoir 43 (see FIG. 1). In order to change the color, the second ball valve 25 of the input control block 19 is moved into the switching position shown in FIGS. 3 and 4; the first ball valve 23 is rotated in order to launch a pig 15 and then moved again into the switching position shown in FIGS. 3 and 4. Then the paint ports 39, 41 are blocked by changing over the second ball valve 25, and the connection from the fluid port 37 to the connection 35 is established.

Then the launched pig 15 is moved by feeding in a preliminary cleaning solvent by way of the fluid port 37. In this case, a slightly contaminated solvent, used previously as the preliminary cleaning agent, is supplied from a preliminary cleaning solution reservoir 67 by way of a switching valve 69. The result is that the pig 15 is moved and forces the paint, located in the pipeline 9, through the end control block 21, of which the first ball valve 45 is opened and the second ball valve 47 is closed, as well as through the connecting line 61 to the distributor control block 63, of which the switching valves are switched in such a way that the paint is recovered and is returned from the paint output 65 to the paint reservoir 43. As soon as the pig sensor 51 at the end control block 21 determines the presence of the pig 15, the second ball valve 47 is opened, while the second ball valve 25 at the input control block 19 is switched over, in order to close the fluid input 37. Thereupon, the first ball valve 23 is actuated again in such a way that a second pig 15 is launched.

Upon completion, the second ball valve 25 is switched over again in such a way that by way of the fluid input 37 an unused, clean solvent can be supplied by way of the fluid input 37 for precision cleaning, with the clean solvent moving this pig 15, which displaces the highly contaminated solvent, which is loaded with residual paint and which may be found upstream of the pig, through the end control block 21 and the connecting line 61 to the distributor control block 63. At the same time, as soon as the second pig 15 begins to move, the second ball valve 47 at the end control block 21 is opened; and this ball valve releases the pig output 55. As a result, the highly contaminated solvent, which is moved by the second pig 15, forces the first pig 15, which may be found in the end control block 21, into the collecting tank 57 together with a portion of the highly contaminated solvent.

After this pig 15 has exited, the second ball valve 47 at the end control block 21 is closed again, so that the rest of the highly contaminated solvent is moved by the second pig through the connecting line 61 to the distributor control block 63, until the second pig 15 arrives in the end control block 21, a state that is signaled by the pig sensor 51. If this is the case, then the first ball valve 45 of the end control block 21 is closed, the second ball valve 47 is opened in order to release the pig output 55, and compressed air is admitted by way of a compressed air connection 74 (see FIG. 8), which is protected by a check valve (not shown), which can be opened by means of pressure from the outside, in order to push the pig 15 out into the collecting tank 57. Then the second ball valve 47 is closed again. At this point, the solvent, which effects precision cleaning and may be found in the pipeline 9, in this operating phase is pushed out of the pipeline 9 by means of a third pig 15 and flows by way of the end control block 21 to the distributor control block 63. This displacement of the third pig takes place in that the fluid port 37 is closed by means of the second ball valve 25 at the input control block 19; and the connection between the paint port 39 to the beginning section 11 of the pipeline 9 is released.

In order to change the color, the paint ports 39, 41 of the input control block 19 are connected to a corresponding paint reservoir for the changed color (in FIG. 1 only one paint reservoir 43 is shown in schematic form for the sake of simplicity). At this point, the third launched pig 15 is moved by means of the new color that is supplied by way of the paint ports 39, 41, so that said third pig moves the solvent, which is just slightly contaminated, to the distributor control block 63 by way of the end control block 21, until the third pig 15 arrives at the end control block 21. This means that the pipeline 9 is filled with the new color up to the end section 13. By closing the first ball valve 45 and opening the second ball valve 47 of the end control block 21, the third pig 15 in turn is discharged into the collecting tank 57 due to the admission of compressed air.

In the course of the subsequent spraying process of the spraying station 3, the excess paint, which is delivered by way of the line section 13, flows in turn through the connecting line 61 to the distributor control block 63. Therefore, in the working cycle of spraying operation/color change, clean paint, clean solvent, slightly contaminated solvent, as well as a solvent which is highly contaminated by residual paint during the preliminary cleaning, flow on an alternating basis to the distributor control block 63. These fluids are divided in the distributor control block 63, as indicated symbolically in FIG. 1, and can be recognized by the solid lines, dashed and dotted lines, thick dashed lines, and/or fine dashed lines. From a port 75, the highly contaminated solvent passes through a line 77 to a collector 73 for disposal; and this collector also receives highly contaminated solvent from the collecting tank 57 for the pigs 15. From a port 79, slightly contaminated solvent, which has previously carried out the precision cleaning of the pipeline 9, passes through the line 81 to the preliminary cleaning solution reservoir 67, while the paint, for recovery purposes, flows to the paint reservoir 43 by way of the paint output 65 and a line 83. FIG. 10 shows that the distributor control block 63 comprises five switching valves 85, 87, 89, 90, and 91. While ball valves are provided for this purpose, it is also possible to consider other types of valve designs, unlike those used in the case of the additional shutoff valves 93 and 95, which are provided in the line sections 11 and 13 and, therefore, have to be piggable, for which reason ball valves are used herein. In particular, an additional paint or fluid circuit (not shown) of an additional paint spraying system is connected to the output of the switching valve 85.

FIG. 11 shows that the pigs 15 are provided for the direction of travel indicated with the arrow 96 and have plate-shaped annular bodies 100 at both ends of a central part 97 between the end parts 98, with these annular bodies being made of an elastomeric material, for example, a synthetic rubber. These annular bodies have inclined sealing lips 99 on the plate edge opposite the direction of travel that is indicated by the arrows 96. In the undeformed state, these sealing lips define an outside diameter that is somewhat larger than the inside diameter of the pipeline 9 and have a larger diameter relative to the central part 97, so that the result is a shape that resembles a diabolo. In the case of pipelines that have sharper bends, the axial length of the central part 97 is chosen correspondingly small, so that the pig 15 moves easily through the bends of the line.

1. A control device for paint spraying systems and application systems which are used, in particular, for the quick-change application of paint in batch productions, with a piping system (1) carrying fluids, such as paint, lacquer, coating particles, and solvents of different cleanliness classes, with individual separating elements, such as pigs (15), enabling a fluid separation inside the piping system (1), characterized in that individual control blocks (19, 21, 63) of the control device are composed of a plurality of actuatable switching valves (23, 25, 45, 47, 86, 87, 89, 90, 91), which enable, on the one hand, the input and/or output of pigs and/or, on the other hand, for this purpose, the simultaneous conveying of fluids in the piping system (1).

2. The control device according to claim 1, characterized in that the piping system (1) has an input control block (19) at the beginning of a piggable pipeline (9) that runs to at least one spraying station (3); and this input control block has two switching valves (23, 25), of which the first switching valve can be actuated as the controlling component of a pig launcher for pigs (15) and the second switching valve can be actuated to release and block the fluid inputs (37, 39, 41) leading to the pipeline (9).

3. The control device according to claim 1, characterized in that the first switching valve (23) of the input control block (19) is arranged, based on the operational fluid flow, downstream of the second switching valve (25) in the block (19) and can be actuated for switching positions in which either an input port (31) for inserting a pig (15) is released, and a connection (35) to the second switching valve (25) is blocked; or this connection (35) is released for the movement of the launched pig (15), and/or the conveying of the respective fluid through the pipeline (9) is released.

4. The control device according to claim 1, characterized in that the second switching valve (25), which is arranged upstream of the first switching valve (23) in the input control block (19), can be actuated for switching positions in which, on the one hand, a paint port (39, 41) is connected to the pipeline (9) by means of the connection (35) with the first switching valve (23); or, on the other hand, this connection (35) is blocked; or, thirdly, the paint port (39, 41) is blocked, and at least one fluid port (37) for solvents of different cleanliness classes is connected to the pipeline (9) by means of the connection (35) with the first switching valve (23).

5. The control device according to claim 1, characterized in that the pipeline (9) continues to run from the respective spraying station (3) to an end control block (21), which comprises two switching valves (45, 47) of which one switching valve (45) can be actuated for blocking and releasing an end (13) of the pipeline (9) that is connected to the block (21); and the second switching valve (47), which is situated downstream, is a controlling component of a pig receiver for pigs (15).

6. The control device according to claim 1, characterized in that a compressed air connection (74) is provided at the fluid connection (49) between the first (45) and the second switching valve (47) of the end control block (21).

7. The control device according to claim 1, characterized in that a sensor (51), which signals the presence of a pig (15), is provided at the fluid connection (49) between the first (45) and the second switching valve (47) of the end control block (21).

8. The control device according to claim 1, characterized in that an output port (55) for pigs (15) can be released or blocked with the second switching valve (47) of the end control block (21).

9. The control device according to claim 1, characterized in that a connecting line (61), which runs from the end control block (21) to a distributor control block (63) and which extends from a connection (59) at the end control block (21), is provided, and this port may be found at a fluid connection (49) between the first (45) and the second switching valve (47).

10. The control device according to claim 1, characterized in that the distributor control block (63) comprises five switching valves (85, 87, 89, 90, 91), which can be actuated for alternating connections from the connecting line (61) to a first and/or a second paint reservoir (43) or to a reservoir (67) for slightly contaminated solvent or to a collector (73) for highly contaminated solvent.

11. The control device according to claim 1, characterized in that the switching valves of at least one control block (13, 21, 63) and preferably all of the control blocks (19, 21, 63) are formed by ball valves (23, 25, 45, 47, 85, 87, 89, 90, 91) comprising ball elements, which can be rotated by means of a controllable drive (27), which can be actuated as a function of the signal of an associated rotary position sensor (29) and/or as a function of the signal of the pig sensor (51) at the end control block (21) and/or as a function of signals from sensors that are distributed in the system of the piping system (1) and that detect the passing of pigs (15).
